(19) United States
(12) Patent Application Publication
(10) Pub. No.: US 2015/0298638 A1
(43) Pub. Date: Oct. 22, 2015

(54) RESTRAINT DEVICE FOR A VEHICLE INTERIOR

(71) Applicant: BOS GMBH & CO. KG, Ostfidern (DE)

(72) Inventors: Matthias MAIER, Esslingen (DE); Huan TRAN, Ostfildern (DE); Wolfgang SCHALLER, Denkendorf (DE); Herbert WALTER, Ebersbach (DE)

(21) Appl. No.: 14/646,061

(22) PCT Filed: Nov. 21, 2013
(86) PCT No.: PCT/EP2013/074419

§ 371 Date: May 20, 2015

(30) Foreign Application Priority Data
Nov. 26, 2012 (DE) 10 2012 221 583.2

(51) Int. Cl. B60R 21/06

(52) U.S. Cl. CPC B60R 21/06

(57) ABSTRACT

Restraint device including a flexible sheet-like structure mounted on a winding shaft so as to be able to be wound up and unwound and shiftable in height between an at least partially extended functional position and a wound-up rest position, wherein the sheet-like structure, on front end face region in the direction of extension, is provided with a dimensionally stable extension profile, and a lifting mechanism, with at least one lifting arm arrangement and which, for the raising and/or lowering of the flexible sheet-like structure, is detachably connected to the extension profile. The lifting arm arrangement is limitedly pivotable about a tilt axis oriented substantially parallel to a rotational axis of the winding shaft, and at least one adjustment unit is provided to adjust the lifting arm arrangement in its tilt about the tilt axis and to fix it in an adjusted tilt position.

The invention relates to a restraint device for a vehicle interior, comprising a flexible sheet-like structure which is held on a winding shaft so as to be able to be wound up and unwound and can be shifted in height between an at least partially extended functional position and a wound-up rest position, wherein the sheet-like structure, on its front end face region in the direction of extension, is provided with a dimensionally stable extension profile, and comprising a lifting mechanism, which has at least one lifting arm arrangement and which, for the raising and/or lowering of the flexible sheet-like structure, can be detachably connected to the extension profile.

A restraint device of this type is known from DE 199 46 382 A1. There a flexible sheet-like structure in the form of a dividing net is held on a winding shaft so as to be able to be wound up and unwound, which winding shaft is rotatably mounted in a cassette housing. The restraint device serves to separate a loading space within a vehicle interior from a passenger compartment in order to prevent the possibility of load being slung out of the loading space into the passenger compartment if the vehicle sharply decelerates.

The object of the invention is to provide a restraint device of the type stated in the introduction, which can be easily adapted to fitting tolerances in the vehicle.

This object is achieved for a restraint device of the type stated in the introduction by virtue of the fact that the lifting arm arrangement is limitedly pivotable about a tilt axis which is oriented at least broadly parallel to a rotational axis of the winding shaft, and that at least one adjustment unit is provided in order to adjust the lifting arm arrangement in its tilt about the tilt axis and to fix it in the adjusted tilt position. It is thereby possible to tailor the restraint device to a concrete installation position within the vehicle interior such that a problem-free transfer of the flexible sheet-like structure from the wound-up rest position into the extended functional position tentered within the vehicle interior is enabled. In the extended functional position of the sheet-like structure, the restraint device enables crashproof fixing of the sheet-like structure in the region of roof mountings, as well as in the region of a supporting structure for the winding shaft, which is likewise fixed attached to the vehicle in a crashproof arrangement. The supporting structure can be formed by a substantially closed cassette housing or by an open frame structure. Since the positioning of appropriate vehicle-fixed receiving fixtures for the supporting structure, on the one hand, and the positioning of associated roof mountings within the vehicle interior, on the other hand, can differ from each other due to fitting tolerances, it is expedient for satisfactory working of the restraint device, and, in particular, of the lifting mechanism, to provide according to the invention an adjustment facility for the lifting arm arrangement. The lifting arm arrangement can consist of one or more pivot arms, or of a telescopic arm arrangement. To the lifting mechanism is preferably assigned a drive device, which advantageously comprises an electric motor. It is also possible for the drive device to be hydraulically or pneumatically configured.

In one embodiment of the invention, two mutually spaced lifting arm arrangements are provided, to each of which is assigned an adjustment unit in order to perform an independent tilt adjustment of each lifting arm arrangement. Preferably, each lifting arm arrangement is formed by two pivot arms, which are coupled to each other in the form of a jackknife or scissors and of which a lower one is pivotably mounted in the region of a supporting structure for the winding shaft and an upper one is pivotably mounted in the region of a lifting profile of the lifting mechanism. The lifting arm arrangements are fully synchronized with each other in order to perform a lifting movement of the lifting profile over the whole of its travel in parallel orientation to a rotational axis of the winding shaft. It is thereby ensured that the lifting profile, which raises and lowers the extension profile of the sheet-like structure, can direct this extension profile securely into the roof mountings.

In a further embodiment of the invention, each lifting arm arrangement is formed by at least one pivot arm, which, by means of a pivot bearing, is arranged in a pivotably movable manner on a supporting structure supporting the winding shaft, and the pivot bearing is held on the supporting structure adjustably about the tilt axis by means of the adjustment unit. In this embodiment, an adjustment of the tilt of the lifting arm arrangement is made in simple manner directly by an appropriate adjustment of the pivot bearing for the at least one pivot arm of the lifting arm arrangement. The mutually independent tilt adjustment of each lifting arm arrangement allows adaptation to different installation positions of the opposite roof mountings of the vehicle interior, so that, in that functional position of the sheet-like structure in which it is extended and fixed in the roof mountings, an offset of the extension profile relative to the rotational axis of the winding shaft is also enabled up to certain limits, without impairing the retention function of the sheet-like structure.

In a further embodiment of the invention, the adjustment unit has an extension arm, which is oriented coaxially to the tilt axis and to which the pivot bearing is fastened, wherein the extension arm is releasable or securable by means of a manually actuable clamp for a rotary movement about the tilt axis. The extension arm is arranged in the region of the supporting structure. The clamp, too, is held on the supporting structure. As the supporting structure, a cassette housing, which can fully receive the flexible sheet-like structure in the wound-up rest position, is advantageously provided.

In a further embodiment of the invention, the clamp has two clamping legs, which flank the extension arm on both sides and which can be drawn together or pushed apart via a screw joint. This is a stable and functionally reliable design of the clamp. The clamp is preferably formed in block-shaped, solid design from a light-metal alloy and is fastened to the inside of the supporting structure.

Further advantages and features of the invention emerge from the claims and from the following description of a preferred exemplary embodiment of the invention, which is represented with reference to the drawings, wherein:

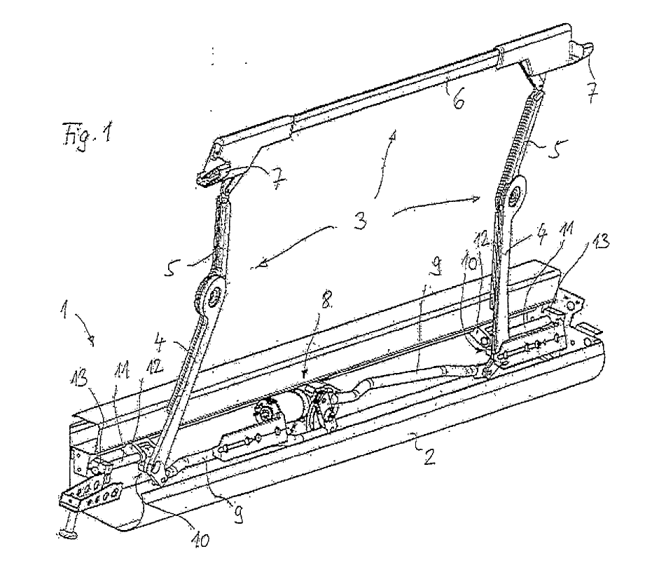

FIG. 1 shows in isometric and partially cut-open representation an embodiment of a restraint device according to the invention, wherein, for reasons of clarity, the flexible sheet-like structure of the restraint device has been omitted, and

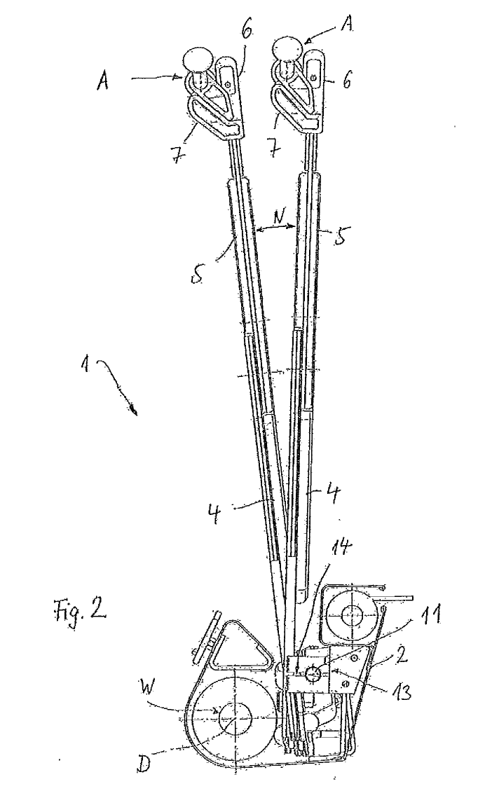

FIG. 2 shows in a sectioned side view the restraint device according to FIG. 1, wherein a lifting mechanism, and an extension profile, received by means of the lifting mechanism, of the flexible sheet-like structure, are represented in two different tilt positions.

A restraint device 1 according to FIGS. 1 and 2 has as the supporting structure a cassette housing 2, in which a winding shaft W is mounted rotatably about a rotational axis D (FIG. 2). A flexible sheet-like structure in the form of a dividing net is held on the winding shaft W such that is can be wound up and unwound. For reasons of clarity, the dividing net is not represented. The dividing net is held on the winding shaft W between a rest position, which is fully recessed in the cassette housing 2, and a tentered functional position, such that it can be wound up and unwound. In the tentered functional position, the dividing net is guided upward approximately vertically to a roof region of a vehicle interior and can there be detachably fixed in roof mountings, which are arranged fixed to the vehicle. To this end, a front end face region of the dividing net is provided with a dimensionally stable extension profile A, which on its opposite end faces is provided with mushroom-shaped mounting hooks. The mounting hooks can be detachably anchored in the roof mountings. In its operating position, the cassette housing 2 is likewise held in a vehicle-fixed manner in the vehicle interior. In this operating position, the cassette housing 2 extends in the transverse direction of the vehicle approximately level with a top edge of the body panel of the vehicle interior and is positioned behind a backrest arrangement of a rear seat bench.

The dividing net, inclusive of its extension profile A, is transferred from the wound-up rest position within the cassette housing 2 into its tentered functional position by means of a lifting mechanism 3 and delivered from the tentered functional position back into the rest position. The lifting mechanism 3 is provided with two mutually spaced lifting arm arrangements 4, 5 and with a lifting profile 6, which on the top side interconnects the lifting arm arrangements 4, 5 and which is oriented parallel to the rotational axis D of the winding shaft W. Each lifting arm arrangement 4, 5 has a lower pivot arm 4 and an upper pivot arm 5, wherein the lower pivot arm 4 is held by means of a pivot bearing 10 in the region of the cassette housing 2. The respective upper pivot arm 5 is mounted in a pivotably movable manner on an end face region of the lifting profile 6. The two lifting arm arrangements are driven upward or downward via a drive device 8, 9 for a lifting movement. To this end, the lower pivot arms 4 are acted on by a transmission linkage 9, which is connected via a crank joint to a gear mechanism of an electric drive motor of the drive device 8. The transmission linkage 9 acts on the two lower pivot arms 4 such that a synchronized, oppositely directed movement of the two lower pivot arms 4 is obtained. The two upper pivot arms 5 of each lifting arm arrangement form jointly with the respective lower pivot arm 4 a jackknife function in order to produce a raising or lowering of the lifting profile 6. In order to ensure that the lifting profile 6 is shifted upward or downward over the whole of its travel substantially parallel to the rotational axis D of the winding shaft W, to the two upper pivot arms 5 of the two lifting arm arrangements is assigned a synchronization unit, which is integrated in the lifting profile 6 and ensures that the upper pivot arms 5 are oriented relative to a longitudinal center axis of the lifting profile 6 always in the same angular amounts, but at reverse angles during a lifting movement.

Moreover, the lifting profile 6 is provided on its opposite end faces with respectively a bar-shaped carrier 7, into which the extension profile A according to FIG. 2 can be delivered so as to be carried by the lifting mechanism 3. Acting on the dividing net in the wind-up direction is a restoring force, which is applied by a volute spring within the winding shaft W.

As a result of the take-up of the extension profile A in the region of the bar-shaped carrier 7 of the lifting profile 6, the lifting mechanism 3 can transport the extension profile A, and thus also the dividing net, in an appropriately positive-locking manner for a lifting operation. A lifting operation can define both a raising and a lowering. The lifting mechanism 3 transports the extension profile A upward in a lifting operation upward out of a parking position in the region of the cassette housing 2, whereby the dividing net is inevitably extended in the upward direction. In the tentered functional position of the dividing net, the lifting mechanism 3 pushes the extension profile A with its lateral mounting hooks into the roof mountings such that the mounting hooks of the extension profile A can be locked in place in the roof mountings. After this, the lifting mechanism 3 can be lowered back into its parking position in the region of the cassette housing. The dividing net remains together with the extension profile A in the tentered functional position. In order to be able to unhook the extension profile A back out of the roof mountings and transfer the dividing net into its wound-up rest position within the cassette housing 2, the lifting mechanism 3 is moved back upward, undergrips the extension profile A by means of the carriers 7 and unhooks the extension profile A from the roof mountings. Next the lifting mechanism 3 is lowered, whereby, inevitably, the extension profile A is jointly lowered and the dividing net winds itself up back onto the winding shaft W within the cassette housing 2 due to the restoring force of the volute spring.

In order to ensure that the lifting mechanism 3, in an upward extension operation, can direct the extension profile A securely into the roof mountings, and to ensure that the lifting mechanism can also re-release the extension profile A from the fixed state in the roof mountings and can lower the extension profile 1 downward, the two lifting arm arrangements 4, 5 of the lifting mechanism 3 are limitedly adjustable in a tilt direction N (FIG. 2) about a tilt axis parallel to the rotational axis D of the winding shaft W. In order to enable this, each pivot bearing 10 of each lifting arm arrangement 4, 5 is held on the cassette housing 2 adjustably about the tilt axis. Each pivot bearing 10 is mounted in a bearing pedestal 12 such that it is limitedly pivotably movable about the tilt axis, which bearing pedestal is fastened to the inside of the cassette housing 2. To this end, a shaft-like extension arm 11, which is oriented coaxially to the tilt axis that supports the pivot bearing 10 and is mounted in a bearing pedestal 12 such that it is limitedly pivotably movable about the tilt axis, is provided. At a distance to the bearing pedestal 12, to the shaft-like extension arm 11 is assigned a mechanical clamp 13, which is likewise fastened to the inside of the cassette housing 2 and has two clamping legs, which can be drawn together or pushed apart manually via a screw joint 14 (FIG. 2), by means of a tool. As a result, a clamping or release of the shaft-like extension arm 11, which constitutes a shaft extension of the pivot bearing 10, is enabled. As soon as the clamp 13 fixes the extension arm 11, the pivot bearing 10 is fixed in its tilt. Thus the corresponding lifting arm arrangement 4, 5 is also fixed in its tilt. For an adjustment of each lifting arm arrangement 4, 5 about the tilt axis in the tilt direction N, the respective clamp 13 is released. After this, the left or right lifting arm arrangement 4, 5 is adjusted in its tilt in such a way relative to the position of the roof mounting that an aligned retraction of the extension profile A into the roof mountings by means of the lifting mechanism 3 is enabled. Next the clamp 13 is fixed in this adjusted position of the lifting arm arrangement 4, 5. The same adjustment operation is performed in the region of the opposite pivot bearing 10 by means of the correspondingly opposite clamp 13. The adjustment unit defined by the clamp 13, the extension arm 11, the pivot bearing 10 and the bearing pedestal 12 is configured identically for each lifting arm arrangement 4, 5, yet is arranged in mirror symmetry to a vertical longitudinal centre axis.

Preferably, the adjustment of the two lifting arm arrangements 4, 5 is made by the lifting mechanism 3, in the non-energized no-load operation of the drive device 8, being pulled upward by an operator, jointly with the received extension profile A, until the extension profile A intrudes into the roof mountings and is locked in place there. In this position of the lifting mechanism 3, in which the carriers 7 of the lifting profile 6 are still undergripping the extension profile A in its hooked fixing position, the fixing of the two clamps 13 is now performed. For the two lifting arm arrangements 4, 5 have inevitably oriented themselves upward during the lifting operation due to the rotational play in the region of the opened clamps 13 such that that tilt of each lifting arm arrangement 4, 5 which is correct for the corresponding lifting operations is obtained. As a result of the subsequent fixing of the clamps 13, the correspondingly correctly adjusted position of each lifting arm arrangement 4, 5 is automatically fixed. After this, the lifting mechanism 3 can be lowered and the restraint device finally put to use.

1. A restraint device for a vehicle interior, comprising a flexible sheet-like structure which is held on a winding shaft so as to be able to be wound up and unwound and can be shifted in height between an at least partially extended functional position and a wound-up rest position, wherein the sheet-like structure, on its front end face region in the direction of extension, is provided with a dimensionally stable extension profile, and comprising a lifting mechanism, which has at least one lifting arm arrangement and which, for the raising and/or lowering of the flexible sheet-like structure, can be detachably connected to the extension profile, wherein the lifting arm arrangement is limitedly pivotable about a tilt axis which is oriented at least broadly parallel to a rotational axis of the winding shaft, and in that at least one adjustment unit is provided in order to adjust the lifting arm arrangement in its tilt about the tilt axis and to fix it in the adjusted tilt position.

2. The restraint device as claimed in claim 1, two mutually spaced lifting arm arrangements are provided, to each of which is assigned an adjustment unit in order to perform an independent tilt adjustment of each lifting arm arrangement.

3. The restraint device as claimed in claim 2, wherein each lifting arm arrangement is formed by at least one pivot arm, which, by means of a pivot bearing, is arranged in a pivotably movable manner on a supporting structure supporting the winding shaft, and in that the pivot bearing is held on the supporting structure adjustably about the tilt axis by means of the adjustment unit.

4. The restraint device as claimed in claim 3, wherein the adjustment unit has an extension arm, which is orientated coaxially to the tilt axis and to which the pivot bearing is fastened, wherein the extension arm is releasable or securable by means of a manually actuable clamp for a rotary movement about the tilt axis.

5. The restraint device as claimed in claim 4, wherein the clamp has two clamping legs, which flank the extension arm on both sides and which can be drawn together or pushed apart via a screw joint.
